(19) United States
(12) Patent Application Publication
(10) Pub. No.: US 2009/0208842 A1
(43) Pub. Date: Aug. 20, 2009

(54) SEPARATOR, METHOD FOR MANUFACTURING SEPARATOR, AND NONAQUEOUS ELECTROLYTE BATTERY

(75) Inventors: Tamotsu Harada, Fukushima (JP); Toru Odani, Fukushima (JP); Nobuyuki Ohyagi, Fukushima (JP); Kensuke Yamamoto, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/368,829

(22) Filed: Feb. 10, 2009

(30) Foreign Application Priority Data
Feb. 15, 2008 (JP) 2008-034710

(51) Int. Cl. H01M 6/14; H01M 2/16; B29C 55/00

(52) U.S. Cl. 429/209; 525/63; 264/291

(57) ABSTRACT

A separator having a fine porous structure and including a polyolefin thermoplastic resin and a block copolymer as constituent materials is provided. The block copolymer including a monomer unit derived from a polyolefin resin and a monomer unit derived from a polymer component, The polyolefin resin has a melting point lower than that of the polyolefin thermoplastic resin, the polymer component being incompatible with polyolefin.

### CROSS REFERENCES TO RELATED APPLICATIONS

The present application claims priority to Japanese Patent Application JP 2008-034710 filed in the Japanese Patent Office on Feb. 15, 2008, the entire contents of which being incorporated herein by reference.

### BACKGROUND

Recently, portable electronic devices such as camera-integrated video tape recorders (VTRs), cellular phones, or laptop computers have appeared and it is contemplated to reduce the size and weight thereof. Research and development of batteries, particularly secondary batteries to be used as portable power supplies of such electronic devices have been actively proceeding in order to improve their energy density.

Among secondary batteries using a nonaqueous electrolyte, a lithium-ion secondary battery has been highly expected and the market for the battery has been growing since a greater energy density is obtained as compared to that of a lead battery which is an aqueous system electrolytic secondary battery in the past and a nickel-cadmium battery. Since characteristics of the lithium-ion secondary battery such as lightweight and high energy density are suitable for application to electrical vehicles and hybrid electrical vehicles, examinations aimed at increasing the size of the battery and achieving a high power discharging capacity of the battery have been increased, particularly, in recent years.

Usually, the lithium-ion secondary battery mainly includes a cathode in which an active material layer which contains a cathode active material such as a lithium compound represented by lithium cobaltate is formed on a collector, an anode in which an active material layer which contains an anode active material such as a carbon material capable of occluding and releasing lithium represented by graphite is formed on the collector, a nonaqueous electrolytic solution in which an electrolyte salt such as lithium salt (LiPF6) is usually dissolved in an aprotic nonaqueous solvent, and a separator which includes a polymeric porous membrane.

In order to satisfy requirements such as the maintenance of the ionic conduction between two poles, capability of holding an electrolytic solution, and resistance against the electrolytic solution, a polymeric porous membrane which mainly includes thermoplastic resins, such as polyethylene and polypropylene is used for the separator used for the lithium-ion secondary battery.

One of the reasons that thermoplastic resins, such as polyethylene and polypropylene are used is that it is suitable to fuse a polymer at 130 to 150° C., to close a continuous hole, and to shut down an electric current in order to ensure the safety of the lithium-ion secondary battery.

The term “shutdown” means a phenomenon that pores of the fine porous membrane are blocked by the fused resin and the electric resistance of the membrane is increased, thereby blocking the lithium ion flow. Further, the term “shutdown temperature” means a temperature when the shutdown occurs. When a fine porous membrane is used as the separator for batteries, it is desirable that the shutdown temperature is as low as possible.

As a function of the separator for batteries, it is necessary to maintain a film shape after pore blockage and keep insulation between electrodes. Therefore, it is preferable that the separator has a high short-circuit temperature. The term “short-circuit temperature” is a temperature when the electric resistance is reduced and the electric current returns in the case where the temperature is increased after shutting down of the separator. For the purpose of ensuring a high safety when the temperature of the battery becomes high, it is preferable to use the separator which has a high short-circuit temperature. There is a need for improvement in the film strength at high temperatures.

In the related art, as the separator which can achieve the improvement in the film strength at high temperatures as well as the improvement in shutdown characteristics, a blend polymer fine porous membrane produced by mixing polypropylene and polyethylene has been proposed.

Further, a separator having a structure in which a polyethylene fine porous membrane and a polypropylene fine porous membrane are stacked is disclosed in Japanese Patent No. 3352801 and Japanese Patent Application Laid-Open (JP-A) Nos. 9-259857 and 2002-321323.

However, when a fine porous membrane of a blend polymer of polypropylene and polyethylene is used, it is difficult to improve the enhancement of the thrust strength of the separator and improvement in shutdown characteristics. In the case of a fine porous membrane of a blend polymer in which the mixing ratio of polypropylene is high, pores are not completely clogged even if it reaches the melting point of polyethylene because the mixing ratio of polyethylene is low. The shutdown characteristics are reduced. On the other hand, in the case of a fine porous membrane of a blend polymer in which the mixing ratio of polypropylene is low, the thrust strength is low because the effect of polyethylene is large.

According to the stacked separators disclosed in Japanese Patent No. 3352801 and JP-A Nos. 9-259857 and 2002-321323, the film strength at high temperatures and shutdown characteristics can be improved. However, it is necessary that a fine porous membrane having a laminated structure is formed by advanced processes, for example, a co-extruding process for combining each of the sheets produced by each extruder and extruding with a dye and a process for extruding each of the sheets, stacking, and heat-sealing. Consequently, it is not inexpensive and highly productive.

It is desirable to provide a separator which exhibits a low shutdown temperature, a high short-circuit temperature, and a high film strength at high temperatures and has a good productivity, the method for manufacturing the separator, and the nonaqueous electrolyte battery.

### SUMMARY

The present disclosure relates to a separator, a method for manufacturing the separator, and a nonaqueous electrolyte battery. More particularly, it relates to the separator suitable for a nonaqueous secondary battery which has a battery exterior member for packing the battery and is lightweight, high-power, and safe, the method for manufacturing the separator, and the nonaqueous electrolyte battery.

A separator which exhibits a low shutdown temperature, a high short-circuit temperature, and a high film strength at high temperatures can be produced by using a block copolymer (BC) containing a monomer unit derived from a polyolefin resin (B) which has a melting point lower than that of the polyolefin thermoplastic resin (A) and a monomer unit derived from a polymer component (C) which is incompatible with polyolefin is provided.

According to an embodiment, there is provided a separator having a fine porous structure and including a polyolefin thermoplastic resin (A) and a block copolymer (BC) as constituent materials, the block copolymer (BC) containing a monomer unit derived from a polyolefin resin (B) and a monomer unit derived from a polymer component (C), the polyolefin resin (B) having a melting point lower than that of the polyolefin thermoplastic resin (A), the polymer component (C) being incompatible with polyolefin.

According to an embodiment, there is provided a nonaqueous electrolyte battery including: a cathode; an anode; an electrolyte; and a separator; wherein the separator has the fine porous structure and the separator including a polyolefin thermoplastic resin (A) and a block copolymer (BC) as constituent materials; the block copolymer (BC) containing a monomer unit derived from a polyolefin resin (B) and a monomer unit derived from a polymer component (C); the polyolefin resin (B) having a melting point lower than that of the polyolefin thermoplastic resin (A), the polymer component (C) being incompatible with polyolefin.

According to an embodiment, there is provided a method for manufacturing a separator. The method includes: mixing a polyolefin thermoplastic resin (A) and a block copolymer (BC) to form a precursor having a microphase-separated structure, the block copolymer (BC) containing a monomer unit derived from a polyolefin resin (B) and a monomer unit derived from a polymer component (C), the polyolefin resin (B) having a melting point lower than that of the polyolefin thermoplastic resin (A), the polymer component (C) being incompatible with polyolefin; and forming through-holes in the precursor.

According to the embodiments, since the separator having the fine porous structure includes the polyolefin thermoplastic resin (A) and the block copolymer (BC) containing the monomer unit derived from the polyolefin resin (B) having a melting point lower than that of the polyolefin thermoplastic resin and the monomer unit derived from the polymer component (C) being incompatible with polyolefin as constituent materials, the shutdown temperature can be made low, the short-circuit temperature can be made high, and the film strength at high temperatures can be made high. Further, a good productivity can be obtained.

Other features and advantages will be apparent from the following description taken in conjunction with the accompanying drawings, in which like reference characters designate the same or similar parts throughout the figures thereof.

Additional features and advantages are described herein, and will be apparent from the following Detailed Description and the figures.

### BRIEF DESCRIPTION OF THE FIGURES

FIG. 1 is a schematic diagram showing the microphase-separated structure.

FIG. 2 is a perspective view showing a structural example of a first example of the nonaqueous electrolyte battery.

FIG. 3 is a cross-sectional view along the line II-II of the spiral electrode body 10 shown in FIG. 2.

FIG. 4 is a cross-sectional view showing a structural example of a second example of the nonaqueous electrolyte battery.

FIG. 5 is a partly enlarged cross-sectional view showing the spiral electrode body 30 shown in FIG. 4.

FIG. 6 is an outline view of an apparatus for measuring the shutdown temperature and the short-circuit temperature.

FIG. 7 is an outline view of the apparatus for measuring the shutdown temperature and the short-circuit temperature.

### DETAILED DESCRIPTION

Hereinafter, embodiments will be described with reference to the drawings. First, the method for manufacturing the separator according to an embodiment will be described. In the method for manufacturing the separator according to an embodiment, the polyolefin thermoplastic resin (A) and the block copolymer (BC) containing the monomer unit derived from the polyolefin resin (B) which has a melting point lower than that of the polyolefin thermoplastic resin (A) and the monomer unit derived from the polymer component (C) which is incompatible with polyolefin are mixed to form a precursor having a microphase-separated structure and then through-holes are formed in the precursor. The term “polymer component” means a component which includes at least a portion of polymer and it may be polymer in itself or a portion of components formed from polymer.

### <Polyolefin Thermoplastic Resin (A)>

Examples of the polyolefin thermoplastic resin (A) include polypropylene resins which are used for usual compression, extrusion, injection, inflation, and blow molding.

Examples of polypropylene include homopolymers, random copolymers, and block copolymers and they may be used alone or two or more of them may be used in combination. The polymerization catalyst is not particularly limited and examples thereof include a Ziegler-Natta catalyst and a metallocene catalyst. The stereoregularity is not particularly limited. Isotactic, syndiotactic, and atactic forms can be used. The weight average molecular weight is preferably 100 thousand to 6 million, more preferably 150 thousand to 3 million, further preferably 200 thousand to 1 million. When the weight average molecular weight is less than 100 thousand, the mechanical durability is not sufficient. When the weight average molecular weight exceeds 6 million, the forming process for the separator becomes difficult.

### <Polyolefin Resin (B)>

Examples of the polyolefin resin (B) which has a melting point lower than that of the polyolefin thermoplastic resin (A) include polyethylene resins which are used for usual compression, extrusion, injection, inflation, and blow molding.

The term “polyethylene resin” used herein includes low density polyethylene resins, medium density polyethylene resins, high density polyethylene resins, linear low density polyethylene resins, and ultrahigh-density polyethylene resins. Their crystalline melting points are preferably 165° C. or less, more preferably 100 to 140° C., most preferably 130 to 140° C. When the crystalline melting point exceeds 165° C., it is too high for a so-called fuse temperature in which an ionic current is blocked by pore blockage, thereby allowing the temperature of the battery to be increased.

### <Block Copolymer (BC)>

The block copolymer (BC) is a block copolymer containing the monomer unit derived from the polyolefin resin (B) which has a melting point lower than that of the polyolefin thermoplastic resin (A) and the monomer unit derived from a polymer component (C) which is incompatible with polyolefin. The polyolefin resin (B) and the polymer component (C) which is incompatible with polyolefin may be one or two or more types.

Examples of the polymer component (C) incompatible with the polyolefin thermoplastic resin (A) include polymethylmethacrylate, poly-α-methylstyrene, polystyrene, polyvinyl pyridine, poly (hydroxyethyl methacrylate), polyacrylic acid, polymethacrylic acid, polyphenyl methyl siloxane, polydimethylsiloxane, polyphenyl methyl siloxane, and polyvinyl methyl siloxane. Particularly, the production method of the block copolymer having polystyrene component is commercially developed and it is preferable taking into consideration the cost.

Examples of the copolymer formed from such a styrene monomer and olefin monomer include polystyrene ethylene-butadiene-styrene (SEBS), styrene-ethylene interpolymer, polystyrene-ethylene-propylene (SEP), styrene-butadiene rubber, and polymers obtained by hydrogenerating these block copolymers. In this regard, the copolymer is not limited thereto. Any copolymer may be used as long as one polymer component is compatible with the polyolefin component.

The term “block copolymer” means a linear copolymer in which a plurality of homopolymer chains are block-bonded. A typical example of the block copolymer is an A-B type diblock copolymer having a -(AA. AA)-(BB.-BB)-structure in which a polymer chain A having a repeating unit A and a polymer chain B having a repeating unit B are bonded at their terminal ends.

The block copolymer in which three or more polymer chains are bonded may be used. When a triblock copolymer is used, any of an A-B-A type, a B-A-B type, and an A-B-C type may be used. A star type block copolymer in which one or more polymer chains are extended radiately from the center may be used. A (A-B) n type or a (A-B-A) n type (four or more blocks) of block copolymers may be used. A graft copolymer has a structure in which a main chain of one polymer hangs a chain of another polymer as a side chain. In the graft copolymer, several different types of polymers can be hung from side chains. Further, a block copolymer like a polymer chain C hanging from block copolymers such as an A-B type, the A-B-A type, and the B-A-B type and the graft copolymer may be used in combination.

When the block copolymer is used, a polymer having a narrow molecular weight distribution can be easily produced as compared to the graft copolymer. Further, it is easy to control the composition ratio and thus it is preferable. Hereinafter, the block copolymer will be mainly described. The description about the block copolymer is applicable to the graft copolymer.

The block copolymer and the graft copolymer are different from a random copolymer and can form a structure (microphase-separated structure) in which a phase A where the polymer chain A is condensed and a phase B where the polymer chain B is condensed are spatially separated. Since two types of polymer chains can be completely separated in phase separation (macro phase separation) by usual polymer blending techniques, they are completely separated into two phases in the end.

In the macro phase separation, the scale of fluctuation generation is about 1 μm and thus the size of a unit cell is 1 μm or more. On the other hand, the unit cell size of the microphase-separated structure obtained from the block copolymer or the graft copolymer is not larger than the size of molecular chain and is an order of several nm to several tens of nm. The microphase-separated structure is a form in which a microscopic unit cell is arranged highly-regularly.

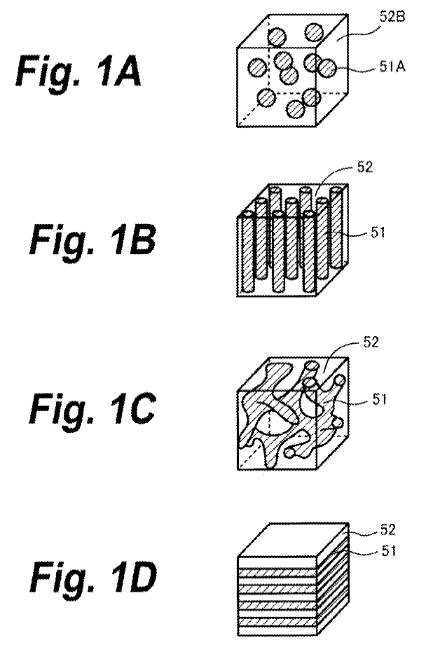

Various forms of the microphase-separated structure will be described. FIG. 1 is a schematic diagram of the microphase-separated structure represented in three dimensions. The structure shown in FIG. 1A is referred to as a sea-island structure. One phase (i.e., an A phase 51) is spherically distributed in the other phase (i.e., a B phase 52). FIG. 1B is referred to as a cylinder structure. One phase (A phase 51) forms a bar-like structure in the other phase (B phase 52). FIG. 1C is called as a bicontinuous structure. FIG. 1D is referred to as a lamella structure and the A phase 51 and the B phase 52 are alternately stacked in a regular manner.

The size and shape of the fine structure depend on the composition ratio and molecular weight of each polymer which forms the block copolymer. When the system includes polymer and a solvent, the size and shape of the fine structure change depending on affinity of each component of the polymer with the solvent. Further, the fine structure can be modified by adding each homopolymer which form the block copolymer.

As with the separator according to an embodiment, when the block copolymer having a polymer component which is not mutually compatible is mixed with polymer, namely, one component which forms the copolymer, the same fine structure is formed. In other words, when the polyolefin thermoplastic resin (A) and the block copolymer (BC) containing the monomer unit derived from the polyolefin resin (B) which has a crystalline melting point lower than that of the polyolefin thermoplastic resin (A) and the monomer unit derived from the polymer component (C) which is incompatible with polyolefin are mixed, the microphase-separated structure (fine structure) can be formed.

The fine porous structure of the separator changes depending on the shape of the fine structure. Therefore, the shape of the fine structure greatly influences characteristics of the separator. Preferable structures for forming the separator are the cylinder structure shown in FIG. 1B and the bicontinuous structure shown in FIG. 1C. When the separator has a dot structure shown in FIG. 1A or the sea island structure, it is difficult to form through-holes in the separator. Further, when the lamella structure shown in FIG. 1D is formed, it is difficult to form through-holes in the separator.

Through-holes in the separator are formed by adding a solvent depending on the composition ratio or molecular weight of each polymer which forms the block copolymer and adding each homopolymer which forms the block copolymer. The formation of through-holes can be confirmed by measuring the air permeability using a Gurley type densometer in accordance with JIS P-8117.

Specifically, the following first to third methods can be used as the method for forming through-holes.

In the first method, a plasticizer which can be easily extracted and removed is added to a polymeric material in the following step and formation is carried out. Then, through-holes are formed by the extraction method in which the plasticizer is removed with an appropriate solvent and a porous structure is formed. That is, in the first method the polyolefin resin (A), the block copolymer (BC), and a plasticizer which is selectively dispersed in the polymer component (C) which is incompatible with polyolefin are heat-mixed, followed by cooling to form a fine structure which includes the polymer component (C). Then, through-holes are formed by extracting and removing the plasticizer.

In the second method, a homopolymer which includes the polymer component (C) which is incompatible with polyolefin is added and through-holes are formed by removing the homopolymer with a solvent in the following step. That is, in the second method, the polyolefin resin (A), the block copolymer (BC), and the homopolymer which includes the polymer components (C) are heat-mixed, followed by cooling to form a fine structure which includes the polymer component (C). Then, through-holes are formed by removing the homopolymer using the solvent.

In the third method, a noncrystalline polymer is used as the polymer component (C) which is incompatible with polyolefin and a fine structure is formed. Thereafter, through-holes are formed by selectively stretching structurally weak amorphous portions. That is, in the third method, the polyolefin resin (A), the block copolymer (BC), and the homopolymer which includes the polymer components (C) are heat-mixed, followed by cooling to form a fine structure which includes the polymer component (C). Thereafter, through-holes are formed by selectively stretching amorphous portions.

In the method for manufacturing the separator according to an embodiment, fine pores formed by the polyolefin resin (B) which has a crystalline melting point lower than that of the polyolefin thermoplastic resin (A) and the polymer component (C) incompatible with polyolefin, namely, the noncrystalline polymer can be easily formed in the process of forming a fine porous membrane.

The separator produced by the above-described method has the fine porous structure and the polyolefin thermoplastic resin (A) and the block copolymer (BC) containing the monomer unit derived from the polyolefin resin (B) which has a melting point lower than that of the polyolefin thermoplastic resin (A) and the monomer unit derived from the polymer component (C) which is incompatible with polyolefin are used as constituent materials.

The separator produced by the above-described method has a structure in which a polymer component of the polyolefin resin (B) which has a crystalline melting point lower than that of the polyolefin thermoplastic resin (A) is dispersed in the polyolefin thermoplastic resin (A) as very fine domain. This allows for preventing shutdown characteristics from being reduced and a separator having a high short-circuit temperature and a low shutdown temperature can be realized.

In the separator for batteries, in order to prevent an abnormal heat generation in the battery and ensure safety, there is a need to shut down in a constant temperature range, block electric currents, and maintain current barrier properties at high temperatures. In the separator, the reduction of shutdown characteristics can be prevented and an abnormal reaction in the battery which may be caused at high temperatures can be suppressed at lower temperature. Further, in the above-described separator, the short-circuit temperature can be made high, the membrane of the separator at high temperatures is not broken, and the contact between electrodes in the battery at high temperatures can be prevented. As a result of these effects, a nonaqueous electrolyte battery excellent in safety can be obtained by using the separator.

For example, when polypropylene is used as the polyolefin thermoplastic resin (A) and polyethylene is used as the polyolefin resin (B), pores are not completely clogged even if each resin reaches the melting point of polyethylene as observed in the fine porous membrane of the blend polymer of polyethylene and polypropylene in which the mixing ratio of polypropylene is high. Thus, the reduction of shutdown characteristics can be prevented.

In the separator produced by the above-described method, fine pores formed by the block copolymer (BC) containing the monomer unit derived from the polyolefin resin (B) which has a melting point lower than that of the polyolefin thermoplastic resin (A) and the monomer unit derived from the polymer component (C) which is incompatible with polyolefin are present. In other words, fine pores formed by a polymer component of the polyolefin resin (B) which has a crystalline melting point lower than that of the polyolefin thermoplastic resin (A) and the polymer component (C) which is incompatible with polyolefin are present. A crystal of a polymer component of the polyolefin resin (B) surrounding fine pores is fused and pores are blocked, which causes the shutdown function.

The partial circumference of fine pores in the separator is formed by a polymer component of the polyolefin resin (B) which has a crystalline melting point lower than that of the polyolefin thermoplastic resin (A). Therefore, rapid pore-closing can be expected at around the melting point. This allows for preventing shutdown characteristics from being reduced and a separator having a high short-circuit temperature and a low shutdown temperature can be realized.

For example, when polypropylene is used as the polyolefin thermoplastic resin (A) and polyethylene is used as the polyolefin resin (B), the reduction of shutdown characteristics observed in the fine porous membrane of the blend polymer of polyethylene and polypropylene in which the mixing ratio of polypropylene is high can be prevented.

A method for confirming the presence of a polymer component of the polyolefin resin (B) and the polymer component (C) present in the dispersed phase interface involves processes of selectively staining the polymer component (C) and then observing with a transmission electron microscope. Specifically, a sample is oxidized and stained with a heavy metal compound such as ruthenium tetrachloride and then ultrathin sections are cut with an ultramicrotome. The sections are observed with a transmission electron microscope.

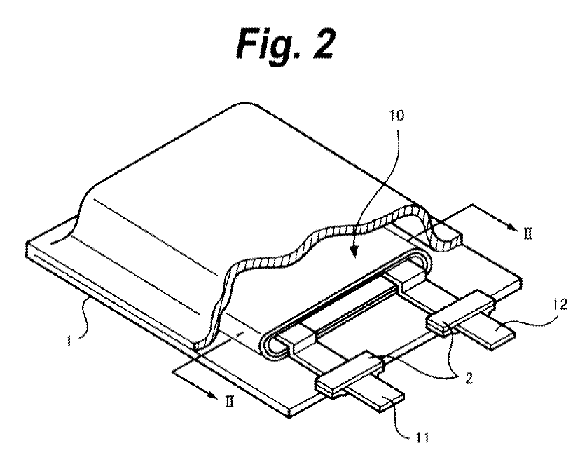

Subsequently, the structure of the first example of the nonaqueous electrolyte battery using the separator will be described. FIG. 2 is a perspective view showing a structural example of the nonaqueous electrolyte battery using the separator. The nonaqueous electrolyte battery has the spiral electrode body 10 on which the cathode lead 11 and the anode lead 12 are mounted in a film-like exterior member 1 and has a flat-type shape.

Each of the cathode lead 11 and the anode lead 12 has a rectangle shape, and is drawn, respectively from the inside of the exterior member 1 to the outside, for example, in the same direction. The cathode lead 11 is made of metallic materials such as aluminium (Al) and the anode lead 12 is made of metallic materials such as nickel (Ni).

The exterior member 1 is, for example, a laminate film and a metal laminate film known in the past such as an aluminum laminated film can be used as the laminate film. It is preferable to use the aluminum laminated film which is suitable for deep drawing and appropriate for the formation of a concave portion housing the spiral electrode body 10.

The aluminum laminated film has a laminated structure in which, for example, an adhesion layer and a surface protection layer are disposed on both sides of the aluminum layer. A polypropylene layer (PP layer) as the adhesion layer, an aluminum layer as a metal layer, and a nylon layer or polyethylene terephthalate layer (PET layer) as the surface protection layer are disposed in the order of the inside, namely, the surface side of the battery element.

In order to improve the adhesion of the cathode lead 11 and the anode lead 12 to the inside of the exterior member 1 and prevent outside air from entering, an adherent film 2 is inserted between the exterior member 1 and the cathode lead 11, and between the exterior member 1 and the anode lead 12. The adherent film 2 is formed of a material having adhesion to the cathode lead 11 and the anode lead 12. For example, the adherent film is preferably made of polyolefin resins such as polyethylene, polypropylene, modified polyethylene, or modified polypropylene in the case where the cathode lead 11 and the anode lead 12 is made of the metallic materials described above.

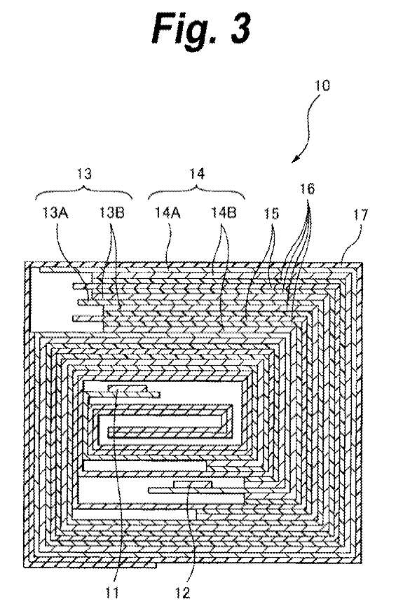

FIG. 3 is a cross-sectional view along the line II-II of the spiral electrode body 10 shown in FIG. 2. The spiral electrode body 10 is formed by stacking a cathode 13 and an anode 14 via a separator 15 and an electrolyte 16 and winding them. The outermost periphery thereof is protected by a protective tape 17.

The cathode 13 has, for example, a cathode current collector 13A and a cathode active material layer 13B formed on both sides of the cathode current collector 13A. In addition, the cathode active material layer 13B may be located only on one side of the cathode current collector 13A. The cathode current collector 13A is made of metal foil such as aluminum foil. The cathode active material layer 13B contains a cathode active material, a conductive agent, and a binder, if necessary.

Known materials such as oxides and sulfides of transition metals; a composite oxide of lithium and transition metals; a composite sulfate of lithium and transition metals; and a composite phosphate of lithium and transition metals can be used as the cathode active material. Specifically, composite oxides of lithium and transition metals such as LiₓCoO₂, LiₓNiO₂, and LiₓMn₂O₄ and a composite phosphate of lithium and transition metals represented by LiFePO₄ can generate a high voltage and they are cathode active materials excellent in energy density.

Products obtained by solid-solutioning or adding one or more different elements in the composite oxide of lithium and transition metals, the composite sulfate of lithium and transition metals, and the composite phosphate of lithium and transition metals can be used. Non-stoichiometric compounds with crystal structures similar to those of the composite oxide of lithium and transition metals, the composite sulfate of lithium and transition metals, and the composite phosphate of lithium and transition metals can be used. The composite oxide of lithium and transition metals, the composite sulfate of lithium and transition metals, and the composite phosphate of lithium and transition metals may be used in combination.

The anode 14 has an anode current collector 14A and an anode active material layer 14B formed on both sides of the anode current collector 14A. In addition, the anode active material layer 14B may be located only on one side of the anode current collector 14A. The anode current collector 14A is made of metal foil such as copper foil.

The anode active material layer 14B include any one, or two or more of the anode material capable of being doped/dedoped with lithium and further may contain the conductive agent and the binder, if necessary. The anode current collector 14A and the anode active material layer 14B may be formed of a plate-like lithium metal.

Usable examples of the anode material capable of being doped/dedoped with lithium include carbon materials, such as a non-graphitizable carbon material and a graphite material. More specifically, carbon materials such as pyrolytic carbons, cokes, graphites, glassy carbons, organic polymer compound firing products, carbon fiber, and activated carbon can be used. Examples of such a coke include pitch coke, needle coke, and petroleum coke. Organic polymer compound firing products are obtained by firing and carbonizing polymeric compounds such as a phenol resin and a furan resin at suitable temperatures.

In addition to this, polymeric compounds, such as polyacethylene and polypyrrole can be used as the anode material capable of being doped/dedoped with lithium. Further, oxides represented by lithium titanate can also be used.

A metal element and metalloid element capable of forming an alloy with lithium may be used alone or in combination. Examples of the metal element and metalloid element capable of forming an alloy with lithium include tin (Sn), lead (Pb), silicon (Si), germanium (Ge), aluminium (Al), indium (In), bismuth (Bi), palladium (Pd), and platinum (Pt). These elements may be used as an alloy containing at least one of these elements or as an intermetallic compound. Further, a mixture of these metals, metalloids, alloys, and intermetallic compounds may be used and further their oxides may be employed. Furthermore, a complex of these material and carbonaceous materials with known anode materials capable of being doped/dedoped with lithium may be used.

The electrolyte 16 contains an electrolytic solution and a polymeric compound which supports the electrolytic solution and is a so-called gel layer. The electrolytic solution contains an electrolyte salt and a solvent to dissolve the electrolyte.

Usable examples of the electrolyte salt include various electrolyte salts usually used for the nonaqueous electrolytic solution. Specific examples thereof include lithium salts such as LiPF₆, LiAsF₆, LiClO₄, LiCF₃SO₃, LiN(SO₂CF₃)₂, LiC(SO₂CF₃)₃, LiAlCl₄, and LiSiF₆. Lithium salts of various boric acid derivatives can also be used. Among lithium salts, LiPF₆ is particularly desirable because it has a relatively high electric conductivity and a stable electric potential. Usually, the concentration of the electrolyte salt in the nonaqueous electrolytic solution is preferably 0.5 to 2.0 mol/l.

In preparing the electrolytic solution, various nonaqueous solvents which are usually used for the nonaqueous electrolytic solution can be employed as solvents for dissolving the electrolyte salt. Specific examples thereof include cyclic carbonates such as propylene carbonate and ethylene carbonate; chain carbonates such as diethyl carbonate and dimethyl carbonate; carboxylates such as methyl propionate and methyl butyrate; and ethers such as y-butyrolactone, sulfolane, 2-methyltetrahydrofuran, and dimethoxyethane. These nonaqueous solvents may be used alone or in combination. Particularly, from the viewpoint of oxidation stability, it is preferable to include carbonate. As an additive agent or a main solvent, cyclic carbonates having carbon double bonds may be used. These various nonaqueous solvents may be partially halogenated before use.

Any polymeric compound may be used as long as it can absorb a solvent to turn into a gel. Examples thereof include ether polymers such as polyethylene oxide and its crosslinking monomer; and fluorinated polymers such as polymethacrylate, ester series, acrylate series, and poly vinylidene fluoride, and vinylidene fluoride-hexafluoropropylene copolymer. These compounds can be used alone or in combination. Among them, from the viewpoint of oxidation-reduction stability, it is desirable to use fluorinated polymers such as poly vinylidene fluoride and vinylidene fluoride hexafluoropropylene copolymer.

Subsequently, the first example of the method for manufacturing the nonaqueous electrolyte battery will be described. First, the cathode active material layer 13B is formed on, for example, the cathode current collector 13A and the cathode 13 is produced. As for the cathode active material layer 13B, for example, the cathode active material, binder, and conductive agent are mixed to prepare a cathode mixture and then the cathode mixture is dispersed in a solvent such as N-methyl-2-pyrrolidone (NMP) to give a paste-like cathode mixture slurry. Next, the cathode mixture slurry is applied to the cathode current collector 13A and the solvent is dried, followed by compression molding with a roll presser to form the cathode active material layer 13B. In this regard, the cathode active material layer 13B may be provided by a vapor growth method typified by a spattering method and a vapor deposition method or a powder sintering method in addition to the coating method.

The anode active material layer 14B is formed on, for example, the anode current collector 14A and the anode 14 is produced. As for the anode active material layer 14B, for example, the anode active material and binder agent are mixed to prepare an anode mixture and then the anode mixture is dispersed in N-methyl-2-pyrrolidone (NMP) to give a paste-like anode mixture slurry. Next, the anode mixture slurry was applied to the anode current collector 14A and the solvent was dried, followed by compression molding with a roll presser to form the anode active material layer 14B. In this regard, the anode active material layer 14B may be formed by a vapor growth method typified by a spattering method and a vapor deposition method or a powder sintering method in addition to the coating method.

Next, the cathode lead 11 is mounted on the cathode current collector 13A and the anode lead 12 is mounted on the anode current collector 14A.

Subsequently, the electrolytic solution and the polymeric compound are mixed using the combined solvent. The resulting mixed solution is applied onto the cathode active material layer 13B and the anode active material layer 14B and then the combined solvent is volatilized to form the electrolyte 16. Then, the cathode 13, separator 15, anode 14, and separator 15 are stacked in this order and then are wound. The protective tape 17 is adhered to outermost periphery thereof in order to form the spiral electrode body 10. Thereafter, the spiral electrode body 10 is sandwiched between the exterior members 1 and then the outer edges of the exterior members 1 are heat-sealed. During the process, the adherent film 2 is inserted between the cathode lead 11 and the exterior member 1, and between the anode lead 12 and the exterior member 1. Thus, the nonaqueous electrolyte battery shown in FIG. 2 is obtained.

Further, the cathode 13 and the anode 14 are not wound after forming the electrolyte 16 thereon, but the cathode 13 and anode 14 are wound via the separator 15 and sandwiched between the exterior members 1. Then, an electrolyte composition which contains the electrolytic solution and a monomer of the polymeric compound may be injected so that the monomer is polymerized in the exterior member 1.

Subsequently, the structure of the second example of the nonaqueous electrolyte battery using the separator will be described. With reference to the second example, an electrolytic solution is used in place of a gel electrolyte 16 in the first example of the nonaqueous electrolyte battery. In this case, the separator 15 is impregnated with the electrolytic solution. In this regard, the same electrolytic solution as that of the first example can be used.

The nonaqueous electrolyte battery having such a structure can be fabricated, for example, in the following manner. The spiral electrode body 10 is fabricated by winding the cathode 13 and the anode 14 in the same manner as described in the first example except for the gel electrolyte 16 is not formed. The spiral electrode body 10 is sandwiched between the exterior members 1. Then the electrolytic solution is injected and the exterior member 1 is sealed.

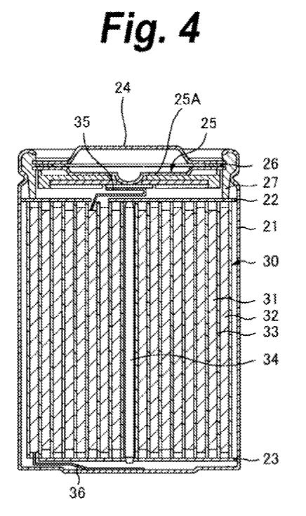

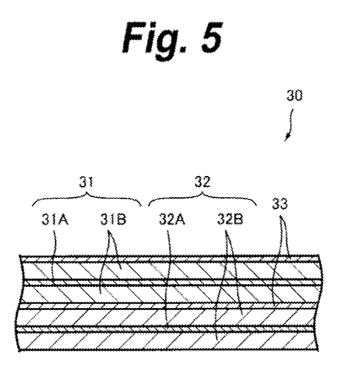

Subsequently, the structure of the third example of the nonaqueous electrolyte battery using the separator will be described with reference to FIGS. 4 and 5. FIG. 4 shows a structural example of the third example of the nonaqueous electrolyte battery using the separator. This nonaqueous electrolyte battery is the so-called cylindrical shape and includes a spiral electrode body 30 in which a band-like cathode 31 and a band-like anode 32 are wound via a separator 33 in a hollow cylinder-like battery can 21 that is the exterior member. The separator 33 is impregnated with an electrolytic solution which is a liquid electrolyte. The battery can 21 is made of iron (Fe) plated with nickel (Ni) and one end thereof is closed, and the other end is opened. In the battery can 21, a pair of insulating plates 22 and 23 are arranged to sandwich the spiral electrode body 30 perpendicularly to a periphery surface thereof.

A battery lid 24, as well as a safety valve mechanism 25 and a positive temperature coefficient (PTC) element 26 which are positioned inside the battery lid 24 are mounted in the open end of the battery can 21 by caulking via a gasket 27 to seal the inside of the battery can 21. The battery lid 24 is made of the same material as the battery can 21, for example. The safety valve mechanism 25 is electrically connected to the battery lid 24 through the PTC element 26. When an internal pressure of the battery becomes more than a certain value due to the internal short circuit or heating from outside, a disk plate 25A is inverted to cut the electric connection between the battery lid 24 and the spiral electrode body 30. The PTC element 26 restricts electric currents, when its resistance increases with an increase in temperature, to prevent unusual heat generation due to high electric currents. The gasket 27 is made of an insulating material and asphalt is applied to the surface thereof.

The spiral electrode body 30 is wound around, for example, a center pin 34. A cathode lead 35 including aluminum (Al) or the like is connected to the cathode 31 of the spiral electrode body 30, and an anode lead 36 including nickel (Ni) or the like is connected to the anode 32. The cathode lead 35 is welded to the safety valve mechanism 25 to be electrically connected with the battery lid 24. The anode lead 36 is welded to the battery can 21 to be electrically connected.

FIG. 5 is a partially enlarged cross-sectional view of the spiral electrode body 30 shown in FIG. 4. The spiral electrode body 30 is formed by laminating and winding the cathode 31 and the anode 32 via the separator 33.

The cathode 31 has, for example, a cathode current collector 31A and a cathode active material layer 31B formed on both sides of the cathode current collector 31A. The anode 32 has, for example, an anode current collector 32A and an anode active material layer 32B formed on both sides of the anode current collector 32A. Each structure of the cathode current collector 31A, the cathode active material layer 31B, the anode current collector 32A, the anode active material layer 32B, the separator 33, and the electrolytic solution is the same as that of the cathode current collector 13A, the cathode active material layer 13B, the anode current collector 14A, the anode active material layer 14B, the separator 15, and the electrolytic solution in the first example.

The nonaqueous electrolyte battery having such a structure may be fabricated, for example, in the following manner. First, the cathode 31 and the anode 32 are respectively fabricated in the same manner as described in the first example.

Next, the cathode lead 35 is fixed to the cathode current collector 31A with welding or the like, and the anode lead 36 is fixed to the anode current collector 32A with welding or the like. Thereafter, the cathode 31 and the anode 32 are wound sandwiching the separator 33 therebetween, a tip portion of the cathode lead 35 is welded to the safety valve mechanism 25, a tip portion of the anode lead 36 is welded to the battery can 21, and the wound cathode 31 and anode 32 are sandwiched between a pair of the insulating plates 22 and 23, and then housed inside the battery can 21. After housing the cathode 31 and anode 32 inside the battery can 21, the electrolyte is injected into the battery can 21 to be impregnated into the separator 33. Thereafter, the battery lid 24, the safety valve mechanism 25, and the PTC element 26 were caulked and fixed to an opening end of the battery can 21 through the gasket 27. As described above, the nonaqueous electrolyte battery shown in FIG. 4 is fabricated.

### EXAMPLES

Examples are described below. However, the embodiments are not to be construed as being limited to these examples.

### Example 1

A polyolefin fine porous membrane was produced using 70 parts by weight of polypropylene of homopolymer (density: 0.90 g/cm³, viscosity average molecular weight: 300,000) and 30 parts by weight of polystyrene-ethylene-butylene-styrene (Kraton G 1651). 0.3 part by weight of tetrakis-(methylene-3-(3′,5′-di-t-butyl-4′-hydroxyphenyl) propionate) methane was mixed as an antioxidizing agent.

Each material was charged into a twin screw extruder having a caliber of 25 mm and a screw length (L/D) of 48 via a feeder. 150 parts by weight of liquid paraffin (kinematic viscosity at 37.78° C.: 75.90 cSt) were injected into each extruder via a side feeder and kneaded at 200° C. at 200 rpm. After the extruding process, the resulting product was immediately cooled and solidified with a cast roller cooled to 25° C. and a sheet having a thickness of 1.5 mm was formed. The sheet was stretched to 7×7 times at 124° C. using a simultaneous biaxial-stretching machine and then the stretched film was immersed in methylene chloride. Liquid paraffin was extracted and removed, followed by drying and heat-treating at 120° C. and then a fine porous membrane was obtained.

### Example 2

A polyolefin fine porous membrane was produced using 70 parts by weight of polypropylene of homopolymer (density: 0.90 g/cm³, viscosity average molecular weight: 300,000) and 30 parts by weight of polystyrene-ethylene-propylene-styrene (Kraton G1730M). 0.3 part by weight of tetrakis-(methylene-3-(3′,5′-di-t-butyl-4′-hydroxyphenyl) propionate) methane was mixed as the antioxidizing agent. Then, a fine porous membrane was obtained in the same manner as described in Example 1.

### Comparative Example 1

A polyolefin fine porous membrane was produced using polypropylene of homopolymer (density: 0.90 g/cm³, viscosity average molecular weight: 300,000). 0.3 part by weight of tetrakis-(methylene-3-(3′,5′-di-t-butyl-4′-hydroxyphenyl) propionate) methane was mixed as the antioxidizing agent. Then, a fine porous membrane was obtained in the same manner as described in Example 1.

### Comparative Example 2

A polyolefin fine porous membrane was produced using a high density polyethylene (density: 0.95 g/cm³, viscosity average molecular weight: 250,000). 0.3 part by weight of tetrakis-(methylene-3-(3′,5′-di-t-butyl-4′-hydroxyphenyl) propionate) methane was mixed as the antioxidizing agent. Then, a fine porous membrane was obtained in the same manner as described in Example 1.

### Comparative Example 3

A polyolefin fine porous membrane was produced using 30 parts by weight of high density polyethylene (density: 0.95 g/cm³, viscosity average molecular weight: 250,000) and 70 parts by weight of polypropylene of homopolymer (density: 0.90 g/cm³, viscosity average molecular weight: 300,000). 0.3 part by weight of tetrakis-(methylene-3-(3′,5′-di-t-butyl-4′-hydroxyphenyl) propionate) methane was mixed as the antioxidizing agent. Then, a fine porous membrane was obtained in the same manner as described in Example 1.

### Comparative Example 4

A polyolefin fine porous membrane was produced using 70 parts by weight of high density polyethylene (density: 0.95 g/cm³, viscosity average molecular weight: 250,000) and 30 parts by weight of polypropylene of homopolymer (density: 0.90 g/cm³, viscosity average molecular weight: 300,000). 0.3 part by weight of tetrakis-(methylene-3-(3′,5′-di-t-butyl-4′-hydroxyphenyl) propionate) methane was mixed as the antioxidizing agent. Then, a fine porous membrane was obtained in the same manner as described in Example 1.

### (Evaluation)

With reference to the fine porous membranes described in Examples 1 and 2 and Comparative examples 1 to 4, the shutdown temperature, short-circuit temperature, and thrust strength at high temperatures were measured in the following manner.

### (Measurement of Shutdown Temperature and Short-Circuit Temperature)

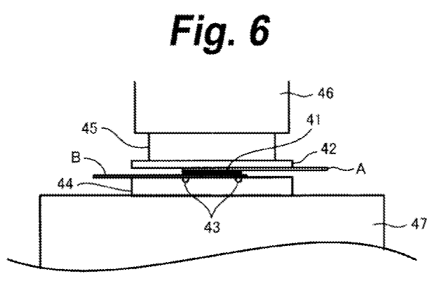

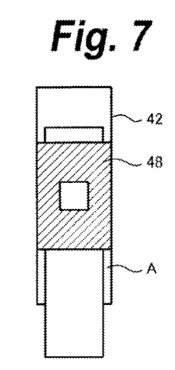

Schematic diagrams of an apparatus for measuring the shutdown temperature and short-circuit temperature is shown in FIGS. 6 and 7. As shown in FIG. 6, two nickel foils (nickel foil A, nickel foil B) with a thickness of about 10 μm were prepared. As shown in FIG. 7, the nickel foil A was fixed on a glass slide 42 by masking with a “Teflon” (registered trademark) tape 48 so as to leave a space (square portion: 10 mm long and 10 mm wide).

As the electrolytic solution, 1 mol/l of lithium borofluoride (LiBF4) solution (solvent: propylene carbonate/ethylene carbonate /y-butyl lactone=1/½ (weight ratio) was used. The nickel foil B was placed on a ceramic plate 44 connected to a thermocouple 43 and then a fine porous membrane 41 of measurement sample which had been immersed in the electrolytic solution for 3 hours was placed on the nickel foil B. The glass slide 42 to which the nickel foil A was attached was placed on the fine porous membrane 41 and a silicon rubber 45 was placed thereon.

The resulting product was placed on a hot plate 47 and heated up from 25° C. to 200° C. at a rate of 15° C./min in a state that a pressure of 1.5 MPa was applied thereto using a hydraulic press machine 46. The impedance change at the time was measured using a LCR meter (alternating current: 1 V, 1 kHz). In the measurement, the temperature when the impedance reached 1000 Ω was defined as the shutdown temperature. The temperature when the impedance fell below 1000 Ω after reaching the pore blockade condition was defined as the short-circuit temperature.

### (Measurement of Thrust Strength at High Temperatures (N/μm))

A fine porous membrane was sandwiched between two stainless-steel washers (inner diameter: 13 mm, outer diameter: 25 mm) and three surrounding points were grasped by clips, followed by immersing in silicone oil (KF-96-10CS, Shin-Etsu Chemical Co., Ltd.) at 160° C. After 1 minute, the thrust test was performed under conditions (curvature radius of the tip of the needle: 0.5 mm, thrust speed: 2 mm/sec) using a handy compression tester (“KES-G5” (trademark), manufactured by Kato Tech Co., Ltd. and then a maximum thrust load (N) was measured. The measured value was multiplied by 1/film thickness (μm), which was defined as the thrust strength (N/μm) at high temperatures.

### (Confirmation of the Presence of Fine Pores Formed by the Block Copolymer)

A sample was oxidized and stained with a heavy metal compound such as ruthenium tetrachloride and then ultrathin sections were cut with a ultramicrotome. The sections were observed with a transmission electron microscope. Then, it was confirmed whether the block copolymer was present in the pore interface.

### (Measurement of Air Permeability)

The air permeability was measured using a Gurley type densometer in accordance with JIS P-8117.

Evaluation results are shown in Table 1.

TABLE 1

| | | | | | PRESENCE OR |
|---|---|---|---|---|---|
| | | | | | ABSENCE OF |
| | SHUTDOWN | SHORT-CIRCUIT | THRUST STRENGTH AT | AIR | NONCRYSTALLINE |
| | TEMPERATURE | TEMPERATURE | HIGH TEMPERATURES | PERMEABILITY | POLYMER |
| | [° C.] | [° C.] | [N/μm] | [sec/100 cc] | IN PORE INTERFACE |
| EXAMPLE 1 | 140 | 190 | 0.005 | 380 | OBSERVED |
| EXAMPLE 2 | 135 | 195 | 0.004 | 400 | OBSERVED |
| COMPARATIVE | 170 | 200 | 0.020 | 500 | NOT OBSERVED |
| EXAMPLE 1 | | | | | |
| COMPARATIVE | 135 | 150 | BROKEN MEMBRANE | 330 | NOT OBSERVED |
| EXAMPLE 2 | | | | | |
| COMPARATIVE | 150 | 200 | 0.005 | 420 | NOT OBSERVED |
| EXAMPLE 3 | | | | | |
| COMPARATIVE | 135 | 160 | BROKEN MEMBRANE | 350 | NOT OBSERVED |
| EXAMPLE 4 | | | | | |

As shown in Table 1, the value of the shutdown temperature in Examples 1 and 2 was close to that of the shutdown temperature observed in the separator of Comparative example 2 which included only polyethylene. Further, the value of the short-circuit temperature was close to that of the short-circuit temperature observed in the separator of Comparative example 1 which included only polypropylene.

Although the thrust strength at high temperatures in Examples 1 and 2 did not reach that of the separator of Comparative example 1 which included only polypropylene, it was sufficiently high. The air permeability almost equivalent to those of Comparative examples 1 to 4 was obtained and the formation of through-holes in the separator was observed.

From the results of the electron microscope observation, it was confirmed that polystyrene of a noncrystalline polymer was present around fine pores in the separators of Examples 1 and 2.

It should be understood by those skilled in the art that various modifications, combinations, sub-combinations and alterations may occur depending on design requirements and other factors insofar as they are within the scope of the appended claims or the equivalents thereof. For example, the case where the present application is applied to the secondary batteries of a flat type, and a cylindrical type has been described in the above-mentioned embodiments. The present application can be similarly applied to the secondary batteries of a button type, a thin type, a large type, and a laminated type. Further, the present application can be similarly applied to not only the secondary batteries but also primary batteries. Further, the present application can be applied to not only the secondary batteries but also primary batteries.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A separator having a fine porous structure the separator comprising:
a polyolefin thermoplastic resin;
and a block copolymer;
the block copolymer containing a monomer unit derived from a polyolefin resin and a monomer unit derived from a polymer component;
the polyolefin resin having a melting point lower than that of the polyolefin thermoplastic resin, and the polymer component being incompatible with polyolefin.

2. The separator according to claim 1, wherein fine pores formed by the block copolymer are present.

3. The separator according to claim 1, wherein the polymer component is a noncrystalline polymer.

4. The separator according to claim 1, wherein the polyolefin resin is a high density polyethylene or a polyethylene composition.

5. The separator according to claim 1, wherein the polyolefin thermoplastic resin is a polypropylene composition.

6. A nonaqueous electrolyte battery comprising:
a cathode;
an anode;
an electrolyte; and
a separator;
wherein the separator has the fine porous structure, and
the separator includes a polyolefin thermoplastic resin and a block copolymer as constituent materials;
the block copolymer containing a monomer unit derived from a polyolefin resin and a monomer unit derived from a polymer component,
the polyolefin resin having a melting point lower than that of the polyolefin thermoplastic resin, and the polymer component being incompatible with polyolefin.

7. A method for manufacturing a separator comprising:
mixing a polyolefin thermoplastic resin and a block copolymer to form a precursor having a microphase-separated structure, the block copolymer containing a monomer unit derived from a polyolefin resin and a monomer unit derived from a polymer component, the polyolefin resin having a melting point lower than that of the polyolefin thermoplastic resin, and the polymer component being incompatible with polyolefin; and
forming through-holes in the precursor.

8. The method for manufacturing the separator according to claim 7, wherein
in the step of forming the precursor, the polymer component is further mixed; and
in the step of forming the through-holes, the through-holes are formed by removing the polymer component.

9. The method for manufacturing the separator according to claim 7, wherein the polymer component is a noncrystalline polymer and the through-holes are formed by stretching the precursor in the step of forming the through-holes.

10. The method for manufacturing the separator according to claim 7, wherein a plasticizer which is dispersed in the polymer component is further mixed in the step of forming the precursor and the through-holes are formed by removing the plasticizer in the step of forming the through-holes.
